(19) United States
(12) Patent Application Publication
(10) Pub. No.: US 2026/0258838 A1
(43) Pub. Date: Sep. 3, 2026

(54) BEARING-SHAFT ASSEMBLY AND METHOD FOR OPERATING A BEARING-SHAFT ASSEMBLY

(71) Applicant: GTW - DR. GEBERT TECHNOLOGIE UND WALZLAGER GMBH, Schweinfurt (DE)

(72) Inventors: Karl GEBERT, Schweinfurt (DE); Gabriele LAUGISCH, Werneck (DE); Fabian SEUFERT, Thundorf (DE); Yannick GRUNEWALD, Rothhausen (DE); Rudiger WATZKE, Neunkirchen am Sand (DE)

(21) Appl. No.: 19/154,520

(22) PCT Filed: Feb. 7, 2024
(86) PCT No.: PCT/EP2024/053083

§ 371 Date: Aug. 7, 2025

(30) Foreign Application Priority Data
Feb. 8, 2023 (DE) 102023000383.2
Nov. 8, 2023 (DE) 102023130963.3

(51) Int. Cl. F16C 27/04; F16C 19/52

(52) U.S. Cl. CPC F16C 27/045; F16C 19/522; F16C 19/525; F16C 19/527; F16C 2233/00

(57) ABSTRACT

Bearing shaft assembly comprising:
a) at least one shaft (1) rotatable or rotating about an axis of rotation (A), which is mounted in at least one bearing (2, 12) arranged coaxially with the axis of rotation (A),
b) at least one clamping element (6) for exerting a clamping force between the at least one bearing (2) and at least one receiving element (8), wherein the at least one bearing (2, 12) is arranged between the at least one receiving element (8) and the shaft (1) for exerting a clamping force between the bearing (2) and the shaft (1),
c) wherein the at least one clamping element (6) is activated by means of a controlling unit (24), in such a way that, by increasing the clamping force, the stiffness of the bearing shaft assembly is increased and/or a resonance range or an eigenfrequency of the bearing shaft assembly or is shifted.

The present invention relates to a bearing shaft assembly and a method for operating a bearing shaft assembly. In particular, the invention relates to a bearing shaft assembly in combination with an electric motor.

Various bearing shaft assemblies (or bearing shaft units) are known in mechanical engineering. Electric motors, spindle units and high-speed shaft bearing systems are usually designed according to the fixed-floating bearing principle, in which the shaft is positioned unambiguously in the radial and axial directions by a fixed bearing on one side and is additionally supported in the axial direction by a floating bearing so that it can move slightly. This allows thermally and/or mechanically induced (axial) displacements of the shaft to be compensated. In known embodiments of such floating bearings, rolling bearings are installed in a sliding bushing and thermally and/or mechanically induced axial displacements of the shaft can be compensated without destroying the rolling bearings due to excessive surface pressures. In order to enable the sliding function, floating bearings do not have high axial and radial stiffness due to the required sliding gap.

Unwanted and harmful vibrations can occur during operation in rotating shafts of machines and motors and in bearings and components coupled to the shaft. At critical rotational speeds or close to the eigenfrequency, a machine part or the entire machine can start to vibrate resonantly. Depending on the geometry and mass distribution of a machine, there may be one or more critical rotational speeds or eigenfrequencies. The excitation of vibrations at the crit al rotational speed results in a vibration maximum at the vibration amplitude and vibration velocity. The effects of such excitation are reduced by high-precision balancing, damping suspension or operation at speeds far removed from the critical rotational speed, i.e. outside the resonance range, and by passing through the critical rotational speed particularly quickly during start-up. However, even these measures cannot completely prevent unwanted vibrations, especially in the case of the well-known rolling bearing systems with fixed-loose bearings.

An example of the problem of such unwanted vibrations are test benches for testing electric drive trains of motor vehicles, which usually comprise an electric motor as the drive, whose vibrations can be transmitted to a test piece. The publication DE 10 2020 214 884 B4 describes a drive unit for a powertrain test bench for testing electric powertrains with an electric motor. A specific configuration of a support device for the electric motor is used for improved vibration damping.

The invention aims to provide a bearing shaft assembly, a method for operating a bearing shaft assembly and an electric motor with a bearing shaft assembly, in each of which the vibration behaviour during operation can be positively influenced.

The task is solved in an embodiment according to the invention by a bearing shaft assembly (or: bearing shaft unit) comprising:
a) at least one shaft rotatable about an axis of rotation or rotating, which is mounted in at least one bearing, in particular arranged coaxially with the axis of rotation,
b) at least one clamping element for exerting a clamping effect or clamping force which acts between the at least one bearing and at least one receiving element, in particular a bearing shield, wherein the at least one bearing or bearings is or are arranged between the at least one receiving element and the shaft, in particular coaxially with the axis of rotation, and/or for exerting a clamping effect or clamping force which acts between the shaft and the at least one bearing,
c) wherein the at least one clamping element, in particular by means of a controlling unit, in such a way that by increasing the clamping effect or clamping force, the stiffness of the bearing shaft assembly can be increased or is increased and/or a resonance range and/or an eigenfrequency of the bearing shaft assembly can be shifted or is shifted.

Instead of the term “bearing shaft assembly”, the term “bearing shaft unit” or “shaft bearing system” can also be used equivalently in all embodiments. Unless otherwise defined, “radial” refers to a direction radial or perpendicular to the axis of rotation of the shaft, and “axial” refers to a direction axial to or along or parallel to the axis of rotation of the shaft.

Forces acting on or in the bearing (bearing forces) and clamping forces are to be understood in particular as forces acting radially to the axis of rotation of the shaft, in particular in the direction of the shaft or in the direction of the receiving element. Nevertheless, the forces acting on the bearing may have components in other directions of action, for example also in the axial direction. The increased clamping force or clamping effect increases in particular the stiffness of the components clamped together in this way, in particular the bearing and the receiving element (for the bearing and/or shaft) or the bearing and the shaft or all three, and thus of the entire bearing shaft assembly.

The clamping element can also be referred to as a clamping device or clamping mechanism or tensioning element or device or fixing element or device and can be designed and, in particular, by means of mechanical or electromechanical drives or actuators with (in particular radial) pressure or force build-up, e.g. by means of wedge mechanisms or also by means of hydraulic or pneumatic pressure actuators.

Rolling bearings, in particular ball bearings or roller bearings, are preferably used as bearings. However, the bearing may also be of a different type, for example an air bearing, gas bearing, fluid bearing or plain bearing.

In one embodiment, at least one or each bearing comprises rolling elements, in particular balls, which are held between a bearing inner ring and a bearing outer ring.

In one embodiment, at least two bearings are provided, which are mounted one behind the other axially with respect to the axis of rotation. In particular, a common clamping element or a separate clamping element for each bearing can now be provided.

In a preferred embodiment, at least one receiving element, in particular a bearing shield, is provided and the bearing or bearings are arranged between the shaft and the receiving element, in particular coaxially with the axis of rotation. The receiving element is preferably arranged radially outside the shaft. A mounting block may also be attached to an end face of the receiving element.

The receiving element can be, in particular, a bearing shield of an electric drive machine or an electric motor, but also a bearing shield or another suitable part of a machine housing or frame of the bearing-shaft assembly or an electric drive machine.

In an advantageous embodiment, the bearing or at least one bearing of the floating bearing type comprises a sliding bushing and the (at least one) clamping element is integrated in the sliding bushing or formed with the sliding bushing. The clamping element is thus derived from or integrated into a sliding bushing of a known floating bearing and further developed by providing an adjustable or controllable clamping function.

In an advantageous embodiment, the clamping element or at least one clamping element is a hydraulically or pneumatically actuated or activatable clamping element.

Preferably, the or each or at least one clamping element, in particular in a sleeve-shaped or ring-shaped section, has at least one cavity (or: a hollow space) which is filled or can be filled with a hydraulic medium and can be subjected to hydraulic pressure in the hydraulic medium. For this purpose, a hydraulic unit is preferably provided which is connected to the at least one cavity via at least one hydraulic line and to the controlling unit via at least one control line. Due to the hydraulic pressure in the cavity, a region of the clamping element, in particular a membrane-like region, located between the cavity and the bearing, in particular in the radial direction, can be pressed or pushed against the bearing or is pressed or pushed. This occurs in particular after an initial expansion movement to overcome radial clearance and subsequent contact with the bearing, preferably its outer ring. Due to the hydraulic pressure, the clamping pressure or clamping force of the clamping element can now be exerted or is exerted on the bearings and thus on the shaft.

The clamping forces or clamping pressures exerted by a predetermined hydraulic pressure can also be adjusted or designed by the number, design and arrangement of the cavity or cavities in the clamping element and by the design of the contact surfaces between the clamping element and the bearing or bearings. The cavity can be formed in particular in the sleeve-shaped section over the entire circumference of the clamping element. Alternatively, the cavity can be formed from individual chambers or partial cavities which are distributed over the circumference of the clamping element and are connected to one another via channels.

In further embodiments, at least one or each clamping element is an electrically or electromechanically actuated or activatable clamping element, in particular a wedge clamping element or a clamping sleeve.

It can be particularly advantageous if the clamping element is manufactured using a 3D printing process. In particular, the clamping element can be made of a metal or a ceramic material or a polymer material.

In a preferred embodiment, the bearing shaft assembly has at least two operating states. In a first operating state, the clamping element is arranged with a small radial clearance to the bearings, in particular corresponding to a floating bearing, and exerts no or only a small clamping force, so that a first stiffness and/or a lower first eigenfrequency or a first resonance maximum at a first critical rotational speed results or is set. In at least one second operating state, however, the clamping element exerts a higher clamping force than in the first operating state, so that a second stiffness which is higher than the first stiffness results and/or a second eigenfrequency which is higher than the first eigenfrequency or a second resonance maximum which lies at a second critical rotational speed which is higher than the first critical rotational speed results or is set. Preferably, the controlling unit switches between the operating states by activating the clamping element and adjusting its clamping force, thereby shifting the resonance range and/or the eigenfrequency of the bearing shaft assembly.

The controlling unit can be initiated manually or operated automatically with a sequence controlling unit. The controlling unit can, for example, comprise a programmable microcontroller.

In a particularly advantageous embodiment, the clamping element or the clamping force is controlled or adjusted depending on at least one or more operating quantities or operating parameters, wherein the operating quantity or the operating parameter preferably comprises at least one or more of the following:
(i) a vibration, preferably a vibration amplitude or a vibration velocity, in the bearing shaft assembly or a coupled component (whereby resonances or eigenfrequencies can be detected in good time and avoided)
(ii) an operating temperature of the shaft and/or the bearing (whereby excessive heating is to be avoided)
(iii) the rotational speed of the shaft
(iv) a mechanical stress.

For this purpose, at least one sensor or a combination of sensors for detecting one or more of these operating quantities or operating parameters is advantageously provided, wherein the sensor(s) is/are preferably arranged in or on the bearing shaft assembly, in particular
(i) at least one vibration sensor,
(ii) alternatively or additionally, at least one temperature sensor,
(iii) alternatively or additionally, at least one rotational speed sensor,
(iv) alternatively or additionally, at least one mechanical stress sensor.

It is particularly advantageous if the controlling unit switches between the operating states depending on one or more of the operating quantities or operating parameters or on one or more of the sensor signals from one or more of the sensors, in particular when a critical threshold, e.g. with regard to a vibration parameter or with regard to the temperature, is reached.

The object of the invention is also solved by an electric motor connected to a bearing shaft assembly according to the invention, wherein the motor shaft is the shaft in the bearing shaft assembly. This makes it possible to provide an electric motor with particularly smooth running, especially at very high speeds.

The object of the invention is further solved by a method for operating a bearing shaft assembly according to an embodiment of the invention, comprising the following steps:
a) accelerating a rotatable shaft of the bearing shaft assembly;
b) detecting or monitoring a vibration parameter of an unwanted vibration of the bearing shaft assembly, such as a vibration amplitude or vibration velocity;
c) determining whether the vibration parameter reaches a critical threshold;
d) When the critical threshold is reached, changing the stiffness of the bearing shaft assembly and/or shifting the resonance range and/or an eigenfrequency of the bearing shaft assembly, in particular by means of the at least one clamping element.

Preferably, the shaft is accelerated in a first operating state with the first stiffness and/or the lower first eigenfrequency or the first resonance maximum at the first critical rotational speed, and when the critical threshold is reached, the system is switched to at least the second operating state, which has the second stiffness, which is higher than the first stiffness, and/or the second eigenfrequency, which is higher than the first eigenfrequency, or the second resonance maximum, which lies at the second critical rotational speed, which is higher than the first critical rotational speed.

Advantageously, when the shaft rotational speed is further increased in the second operating state, the system is switched back from the second operating state to the first operating state when the critical threshold is reached again.

In a further embodiment, the bearing shaft assembly is operated in the second operating state and the clamping element and/or the bearing shaft assembly is relieved by regular, preferably short-term switching to the first operating state. For example, the proportion of time spent in the second operating state can be four to eight times the time spent in the first operating state. This measure has proven to be useful in order to prevent undesirable jamming or wedging of the clamping element during operation, while still allowing thermal expansion of the shaft.

Further advantageous designs and further developments according to the invention also result from the respective dependent patent claims and also from the following description.

The invention is further explained below with reference to the drawings using examples of embodiments. The following schematic diagrams show:

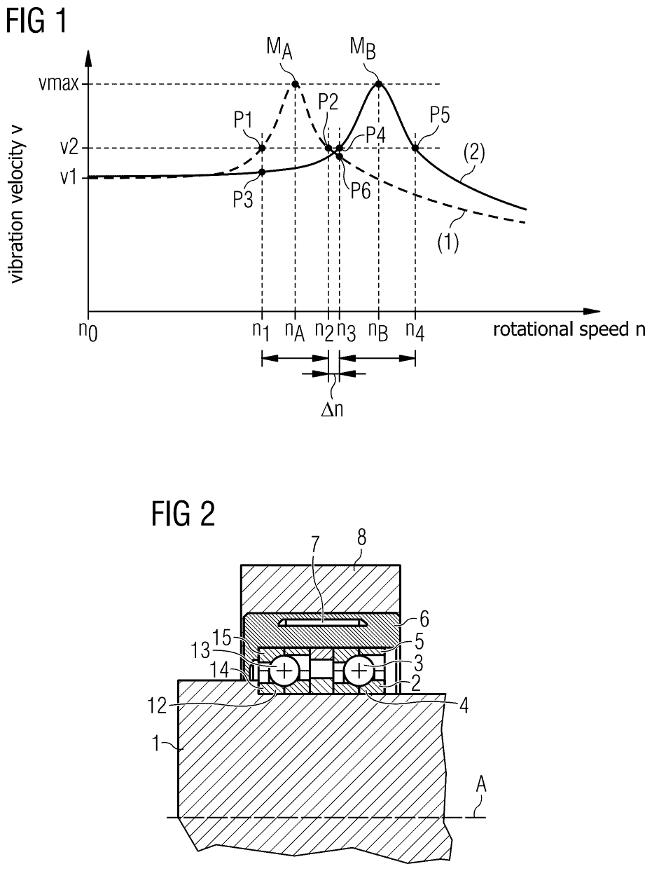

FIG. 1 a diagram illustrating a relationship between vibration velocity and rotational speed in a bearing shaft assembly;

FIG. 2 a sectional view of a bearing shaft assembly according to the invention;

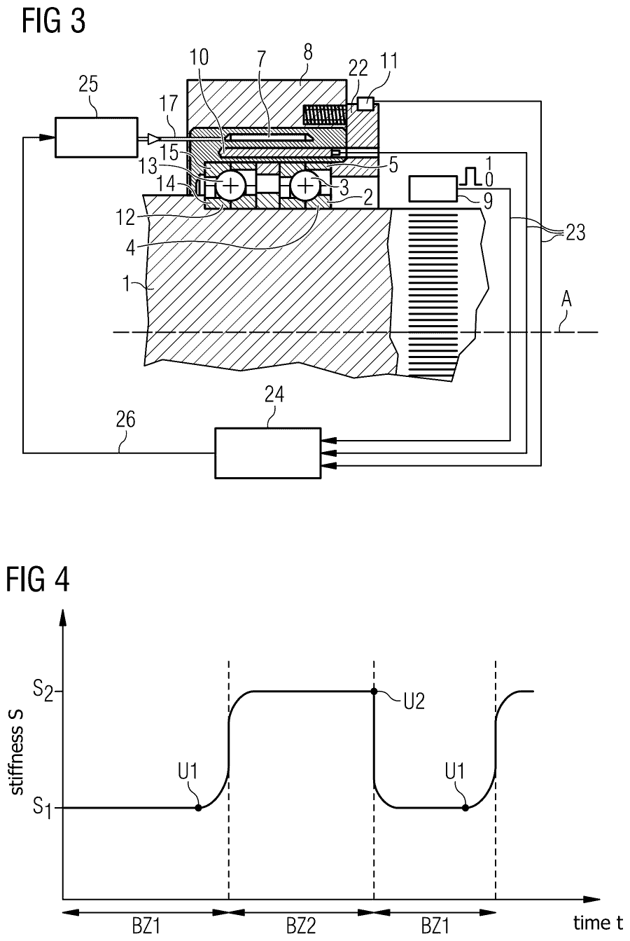

FIG. 3 is a sectional view of a bearing shaft assembly according to FIG. 2 with associated control components;

FIG. 4 a diagram illustrating the variation in stiffness of the bearing shaft assembly over time t;

Corresponding parts and dimensions are designated by the same reference numerals in FIGS. 1 to 4.

FIG. 1 shows a diagram illustrating the relationship between a vibration velocity v of a bearing shaft assembly and the rotational speed n of a shaft of the bearing shaft assembly. Such a relationship exists in particular in a bearing shaft assembly as shown in FIG. 2 with a shaft 1 and at least one bearing 2, in particular a floating bearing, for the shaft 1.

The vibration velocity v, specified in millimetres per second, at which the bearing shaft assembly vibrates, correlates with the rotational speed n at which the shaft 1 of the assembly rotates or is driven and which can be specified in 1/s or also in rpm. Similarly, a vibration amplitude with which the bearing shaft assembly vibrates correlates with the rotational speed n of the shaft 1.

Curves (1) and (2) show a typical dependence of the vibration velocity v of the bearing shaft assembly on the rotational speed n of the shaft, in particular shaft 1, for different stiffnesses S of the bearing shaft assembly. Curve (1) illustrates the vibration behaviour of a bearing shaft assembly with a lower stiffness S=S₁. Curve (2) illustrates the vibration behaviour of a bearing shaft assembly with a higher stiffness S=S₂, wherein S₂ is greater than S₁.

In general terms, stiffness S is the resistance of a body to elastic deformation caused by external loads, i.e. by force and/or moment, and is determined by the material of the body and its geometry. When considering the stiffness S of the bearing shaft assembly, the respective stiffnesses of the individual components of the bearing shaft assembly and how (firmly) the individual components are connected to each other are therefore important.

In curve (1), which shows the vibration behaviour of the bearing shaft assembly with the lower stiffness S₁, the vibration velocity v increases with increasing rotational speed n, starting from a low vibration velocity v1 at a lower rotational speed n₀ and then reaching a higher value v2 (with v2>v1) of the vibration velocity v at a point P1=(n₁, v2) at a rotational speed n₁.

This value v2 of the vibration velocity is already regarded as a threshold (or limit value) that should not actually be exceeded. In other words, a desired or maximum permissible range of vibrations, expressed here by the vibration velocity v, should lie between v1 and a maximum of v2.

Within the subsequent rotational speed range or interval [n₁, n₂] between this rotational speed n₁ as the lower interval limit and a rotational speed n₂ as the upper interval limit with n₂>n₁, the vibration velocity v rises even more steeply and a resonance maximum M_{A} is reached, along with a resonance range around this resonance maximum M_{A}.

The resonance maximum M_{A} lies at a critical rotational speed n_{A}, with n₁<N_{A}<n₂, at which the bearing shaft assembly oscillates at its eigenfrequency or resonance frequency and oscillates at the maximum vibration velocity vmax, i.e. M_{A}=(N_{A}, vmax). In the range of the eigenfrequency, the so-called resonance range, the assembly undergoes natural vibrations which lead to undesirably high vibration velocities v or also to high vibration amplitudes.

After passing the critical rotational speed n_{A} and a further increase in the rotational speed n>n_{A}, the vibration velocity v decreases again and then falls below the threshold v2 of the vibration velocity v at the upper rotational speed n₂ as the upper interval limit at point P2 and remains below v2 for n>n₂.

The rotational speed range [n₁, n₂] between rotational speeds n₁ and n₂ is therefore a range or interval in which the vibration velocity v is above the permissible threshold v2 and is therefore considered too high. A rotational speed n in this rotational speed range [n₁, n₂] with a given stiffness S₁ of the system, in particular of the bearing shaft assembly, should therefore not be assumed at all or only for as short a time as possible.

The second curve (2) in FIG. 1 shows the vibration behaviour of the bearing shaft assembly at the higher stiffness S₂. Like curve (1), curve (2) also starts at the low vibration velocity v1 at the lower rotational speed no, but at rotational speed n₁ at point P3, it is still barely above the initial vibration velocity v1 and remains well below the critical threshold v2 of the vibration velocity v throughout the entire rotational speed range [n₁, n₂]. The curve (2) only reaches this critical threshold v2 at point P4=(n₃, v2) at a rotational speed n₃ that is greater than the rotational speed n₂ (n₃>n₂), i.e. above the rotational speed range [n₁, n₂].

In curve (2), the vibration velocity v also increases within the subsequent rotational speed range [n₃, n₄] between rotational speed n₃ and rotational speed n₄ with n₃<n₄ and a resonance maximum M_{B}=(n_{B}, vmax) is now reached again in a resonance range at a critical rotational speed n_{B}, with n₃<n_{B}<n₄, and then, with a further increase in rotational speed n>n_{B}, the vibration velocity v decreases again and then, at the upper rotational speed n₄ at point P5=(n₄, v2), falls below the threshold v2 of the vibration velocity v and then remains below v2 for n>n₄.

The resonance range with the maximum M_{B} at curve (2) with the higher stiffness S₂ is therefore at a higher critical rotational speed n_{B}>n_{A} than the maximum M_{A} at curve (1) with the lower stiffness S₁.

These relationships with different resonance ranges or critical rotational speeds n_{B}>n_{A} at different stiffnesses S₂>S₁ are now implemented in a new and advantageous way in a technical solution according to the invention.

A technical possibility is provided for adjusting and controlling the stiffness of the bearing shaft assembly from the first stiffness S₁ to the second higher stiffness S₂ and vice versa, even during operation. This is achieved in the bearing by increasing the clamping effect or clamping force or bearing force between the bearing and the shaft by means of at least one clamping element or a clamping device (or: tensioning element or device, fixing element or device).

FIG. 2 shows an example of an advantageous hydraulic clamping element on an advantageous floating bearing with ball bearings and a sliding bushing further developed into a clamping element.

Apart from hydraulic pressure actuators as clamping elements, the invention can be implemented with other embodiments of the clamping element, in particular with other clamping mechanisms, e.g. by means of mechanical or electromechanical drives or actuators with radial pressure or force build-up, e.g. by means of wedge mechanisms and/or clamping sleeves with clamping nuts or also by means of pneumatic pressure actuators. Other embodiments of floating bearings, e.g. with (other) deep groove ball bearings, spherical roller bearings, cylindrical roller bearings, toroidal roller bearings, etc., are also possible.

The representation in FIG. 2 is cut according to a vertical sectional plane along the axis of rotation A of the rotatable shaft 1. On the underside of the assembly, which is not shown, the components are essentially identical in design to those on the upper side of the assembly shown, or are essentially rotationally symmetrical with respect to the axis of rotation A.

The bearing shaft assembly shown in FIG. 2 comprises a shaft 1 rotatable about an axis of rotation A, in particular a drive machine shaft or electric motor shaft, which is rotatably mounted in two bearings 2 and 12 arranged one behind the other axially with respect to the axis of rotation A and mounted coaxially with respect to the shaft 1 with respect to the axis of rotation A. The first bearing 2 comprises rolling elements, in particular balls, 3, which are held between a bearing inner ring 4 and a bearing outer ring 5, and the second bearing 12 comprises rolling elements, in particular balls, 13, which are held between a bearing inner ring 14 and a bearing outer ring 15. The two bearings 2 and 12 are arranged radially between the shaft 1 and a clamping element 6.

The clamping element 6 is formed from or integrated into a sliding bushing of a known floating bearing and further developed by providing an adjustable or controllable clamping function. Such a sliding bushing has a low radial clearance with respect to the bearings 2 and 12 or, even when free of play, exerts at least only a low radial and thus also axial clamping effect or clamping force via the bearings 2 and 12 on the shaft 1, so that the mounted shaft 1, as is usual with a floating bearing, enjoys a certain degree of freedom of displacement or expansion in the axial direction.

The sliding bushing or clamping element 6 is now in turn held within a receiving element 8, in particular a bearing shield. A mounting block (or end flange) 22 is preferably fastened or arranged on the end face of the bearing shield or receiving element 8 and sliding bushing 6, as well as on the outer ring 5 of the bearing 2, as shown, for example, in FIG. 3. The two bearings 2 and 12 thus together form a rolling bearing for the shaft 1, which is designed in principle as a floating bearing for the shaft 1 within the receiving element 8 by means of the sliding bushing (and the play or sliding gap provided by this) of the clamping element 6, thus enabling the shaft 1 to undergo a certain axial displacement to compensate for the distance. In other words, the clamping element 6 is preferably designed in a sleeve shape or ring shape or has a sleeve-shaped or ring-shaped section.

In a further development of the sliding bushing as a clamping element 6 according to the invention, the bearing pressure or the bearing force, at least the radial bearing pressure or the radial bearing force, can now be adjusted by the clamping effect and thus the stiffness of the bearing shaft assembly, thereby shifting the eigenfrequency or critical rotational speed as already described, in particular with reference to FIG. 1.

At least one cavity (or hollow space) 7 is now provided in the sliding bushing or the sleeve- or ring-shaped section of the clamping element 6, which cavity is filled or fillable with a hydraulic medium and can be subjected to hydraulic pressure in the hydraulic medium. This embodiment can be produced in particular by additive manufacturing (3D printing).

Due to the hydraulic pressure in the cavity 7, the membrane-like area of the clamping element 6 located between the cavity 7 and the bearing 2 or 12 or the receiving element 8 can be pressed radially outwards or inwards. As a result, this diaphragm-like region of the clamping element 6 initially overcomes the radial clearance or the sliding gap in an expansion movement and then, due to the hydraulic pressure, exerts a clamping pressure or a radial clamping force of the clamping element 6 on the receiving element 8 and/or on the bearings 2 and 12, in particular on their bearing outer rings 5 and 15, and thus also via the bearing inner rings 4 and 14 on the shaft 1. This clamping fixes the shaft 1 axially or causes axial clamping forces or holding forces. These radial and axial clamping forces now increase the stiffness of the bearing shaft assembly.

The clamping forces or clamping pressures exerted by a predetermined hydraulic pressure can also be adjusted or designed by the number, design and arrangement of the cavity or cavities 7 in the clamping element 6 and by the design of the contact surfaces between the clamping element 6 and the bearings 2 and 12 or their outer rings 5 and 15 and/or the receiving element 8.

The cavity 7 can be formed in particular in the sleeve-shaped section over the entire circumference of the clamping element 6. Alternatively, the cavity can be formed from individual chambers or partial cavities which are distributed over the circumference of the clamping element 6 and are connected to one another via channels. In addition, the cavity 7 can be separated from the environment by a radially outer surface of the clamping element 7 or by an outer membrane forming the sleeve-shaped section. The outer membrane is pressed radially outwards and radially displaced outwards when the cavity 7 is acted upon by a pressure-transmitting medium. In this way, the clamping force is transmitted radially outwards by the membrane to the receiving element 8 and supported by the latter.

According to the embodiment shown in FIG. 3, a hydraulic unit 25 is provided for generating and adjusting the hydraulic pressure, which is hydraulically connected via a hydraulic line 17 to the at least one cavity 7 in the clamping element 6 and feeds in the hydraulic medium under the intended hydraulic pressure. The hydraulic medium is generally a hydraulic oil, but can also be another liquid, e.g. a silicone oil.

Even if, in the embodiment, a clamping element 6 is assigned to several bearings 2 and 12, each bearing 2 and 12 can also be assigned its own clamping element for individual adjustment of the clamping force.

The hydraulic pressure in at least one cavity 7 and thus the stiffness is preferably adjusted depending on certain operating quantities or parameters, which are measured for this purpose by means of corresponding sensors.

In particular, the following may be generated and evaluated:
(i) sensor signals from a rotational speed sensor 9 for the measured current rotational speed n of the shaft 1 and
(ii) sensor signals from a temperature sensor 10, which is arranged on or in the clamping element 6 in the vicinity of the pressing surface to the bearings 2 and 12 for monitoring the temperature at the bearing 2 and 12, and
(iii) sensor signals from a vibration sensor 11, which may be arranged, for example, on the receiving element 8 or on the mounting block 22 and measures the current vibrations, in particular vibration amplitudes and/or vibration frequencies or vibration velocities.

The temperature sensor 10 is arranged spatially close to the rolling bearing 2 and 12, in which considerable heat is generated during operation due to friction in the bearing.

Sensors 9, 10 and 11 are each connected via a sensor signal line 23 to a controlling unit 24, which evaluates the sensor signals and generates control signals depending on at least one of the sensor signals and sends them to the hydraulic unit 25 via a control line 26. The sensor signals and also the control signals can be analogue or digital signals.

The controlling unit 24 can control the hydraulic unit 25 electrically or pneumatically so that it in turn supplies the cavity 7 with hydraulic fluid at a specific pressure via the hydraulic line 17.

The hydraulic pressure and thus the clamping pressure or the clamping force of the clamping element 6 can be varied continuously or switched in several stages or even only binarily between two values.

FIG. 4 shows a switchover between a first operating state BZ1 with a low clamping pressure or a low clamping force, which may also be zero, i.e. in particular a deactivated or switched-off clamping element 6, and a second operating state BZ2 with a significantly higher clamping pressure or a significantly higher clamping force, i.e. in particular an activated or switched-on clamping element 6. In the first operating state BZ1, the bearing shaft assembly assumes a lower value of stiffness S₁ since the bearing 2 and 12 with the sliding bushing 6 function essentially like a conventional floating bearing due to the low or practically non-existent (hydraulic) clamping pressure or the low or practically non-existent (hydraulic) clamping force and allow the shaft 1 a certain axial displacement. In the second operating state BZ2, however, the bearing shaft assembly now assumes a higher value of stiffness S₂ due to the higher (hydraulic) clamping pressure or the higher (hydraulic) clamping force exerted in the connection from the shaft 1 via the bearing 2 and 12 and the clamping element 6 to the receiving element 8. The switchover according to FIG. 4 is performed by the controlling unit 24, which instructs the hydraulic unit 25 via the control line 26 to increase the hydraulic pressure in the cavity for switching from operating state BZ1 to operating state BZ2 and to reduce it for switching from operating state BZ2 to operating state BZ1.

These two stiffness values S₁ and S₂ can now be used for curves (1) and (2) according to FIG. 1 to shift the resonance range and the eigenfrequency or critical rotational speed by selecting the hydraulic pressure difference according to the desired shift of the maximum M_{A} at the critical rotational speed n_{A} at curve (1) to the maximum M_{B} at the critical rotational speed n_{B} at curve (2) with the higher stiffness S₂. This assignment is usually determined empirically and specified for a given bearing shaft assembly with or without correspondingly coupled components.

In other words, the targeted clamping of the sliding bushings with integrated rolling bearings to regulate the system stiffness and the resulting vibration amplitudes allows the eigenfrequencies to be shifted and passed through as required. The stiffness can be actively regulated with the aid of the clamping mechanism in order to shift the eigenfrequencies of shaft-bearing systems and to extend the usable rotational speed range. For this purpose, sliding bushings are held in a position that is not critical for the rolling bearings by means of clamping mechanisms, and the stiffness of the connection between the rolling bearing and the bearing shield is specifically regulated. This changes the system stiffness, increases the eigenfrequencies and reduces the vibration amplitudes in the previously given rotational speed range. The maximum rotational speed of the clamped shaft-bearing system can be increased without damage to the rotating and stationary components. It is now also possible to enter previously critical rotational speed ranges and pass through them depending on the system design. Furthermore, depending on the design of the shaft-bearing system, it is possible to deactivate the clamping after passing through the previous natural frequency range and continue operating at supercritical rotational speeds.

An operating method can, in an advantageous embodiment according to the embodiment shown in FIG. 1 in combination with FIG. 4, follow the following control of the stiffness and thus of the vibration velocity as a function of the rotational speed by means of the clamping effect or the hydraulic pressure. Preferably, the rotational speed n is continuously measured with the rotational speed sensor 9 and the vibration velocity v is continuously measured with the vibration sensor 11.

When the rotational speed n is increased, the curve (1) with the low stiffness S₁ is initially followed in the first operating state BZ1 with a normal loose bearing up to point P1 at rotational speed n₁ and the critical threshold v2 of the vibration velocity, and then the system switches to the second operating state BZ2 with the high stiffness S₂ and thus falls to point P3 on curve (2). Now, with the rotational speed n continuing to rise, follow curve (2) with the higher stiffness S₂ over the entire rotational speed range [n₁, n₂], thus avoiding the resonance range around the maximum M_{A} and remaining below the critical threshold v2. When the critical threshold v2 on curve (2) is reached at point P4 at rotational speed n₃, the system switches back to the first operating state BZ1, falling from point P4 to point P6 on curve (2) and following curve (1) again, thereby avoiding the resonance range around the maximum M_{B} so that the vibration velocity remains below the critical threshold v2 over the entire rotational speed range.

In embodiments, the bearing shaft assembly can be transferred from the first operating state BZ1 to the second operating state BZ2 with the aid of the clamping element 6, for example. In the first operating state BZ1, the bearing shaft assembly has a first, lower stiffness S₁. If the measured vibration of the bearing shaft assembly rises above a threshold shortly before or within a rotational speed range, the bearing shaft assembly is transferred from the first to the second operating state BZ2, in which a second, higher stiffness S₂ is effective. In the second operating state BZ2, a critical rotational speed range is bypassed. The critical rotational speed that would come into effect in the bearing shaft assembly with lower stiffness S₁ is passed through without or with a significantly lower vibration maximum. When exiting the critical rotational speed range, the bearing shaft assembly is returned to the first operating state BZ1 with the lower stiffness S₁. This means that the critical rotational speed range, which would occur with the bearing shaft assembly with higher stiffness S₂, can also be passed through without a vibration maximum occurring or with the vibration maximum occurring being significantly reduced.

The bearing shaft assembly can thus be operated through critical rotational speed ranges by the targeted use of the different operating states BZ1 and BZ2, whereby the vibration maxima to be expected there are avoided.

In one embodiment, the bearing shaft assembly is normally operated, or for the majority of the operating time, in the second operating state BZ2, i.e. with the clamping element 6 activated or subjected to high hydraulic pressure and with higher stiffness S₂, and repeated brief deactivation and reactivation of the clamping element, i.e. brief switching to the first operating state BZ1 and switching back to the second operating state BZ2, provides relief, in particular thermal relief, for the bearing shaft assembly.

In a modification not shown with a hollow shaft, the arrangement can also be reversed, i.e. the receiving element or the bearing is inside and the shaft is outside as viewed from the axis of rotation.

Further aspects and embodiments according to the invention are also described below and can be claimed independently:
a) Targeted clamping of sliding bushings with integrated rolling bearings in order to regulate the system stiffness and the vibration amplitudes that occur, with the aim of shifting the eigenfrequencies and passing through them as required.
b) The stiffness of roller bearing systems is actively regulated by means of clamping mechanisms in order to shift the eigenfrequencies of shaft-bearing systems and thus extend the usable rotational speed range.
c) For this purpose, sliding bushings are held in a position that is not critical for the rolling bearings by means of clamping mechanisms, and the stiffness of the connection between the rolling bearing and the bearing shield is specifically regulated. This changes the system stiffness, increases the eigenfrequencies and reduces the vibration amplitudes in the previously given rotational speed range. The maximum rotational speed of the clamped shaft-bearing system can be increased without damage to the rotating and stationary components.
d) It is now possible to enter previously critical rotational speed ranges and pass through them depending on the system design. Furthermore, depending on the design of the shaft-bearing system, it is possible to deactivate the clamping after passing through the previous natural frequency range and continue operating at supercritical rotational speeds.
e) Short increases in vibration amplitude when passing through or resetting the clamping mechanism can be made uncritical by means of damping or design measures.
f) The clamping of the sliding bushing can be specifically influenced based on vibration amplitudes, vibration velocities, thermal and/or mechanical conditions in the system.
g) Near the eigenfrequencies of shaft-bearing systems, the vibration amplitudes increase continuously and can reach very high values depending on the damping characteristics of the system. High vibrations cause mechanical damage to rolling bearings, rotors and other components.
h) Electric motors, spindle units and fast-rotating shaft bearing systems are usually designed according to the fixed-floating bearing principle in order to compensate for thermally and/or mechanically induced shaft misalignments. For this purpose, the rolling bearing or bearings are mounted in a sliding bushing. This can compensate for thermally and/or mechanically induced shaft displacement without destroying the rolling bearings due to excessive surface pressures. In order to be able to perform the sliding function, non-locating bearings do not have high axial and radial stiffness due to the required sliding clearance. If the sliding gap is bridged and a connection to the bearing shield is established, the axial and radial stiffness of the shaft-bearing system increases. At the same time, the vibration amplitudes can be reduced compared to the non-fixed shaft-bearing system. This makes it possible to achieve higher rotational speeds with the same vibration velocity level.
i) By fixing the sliding bushing in a targeted manner and with a suitable bearing system design, eigenfrequencies that are present in conventional solutions can be passed through. After passing through, the clamping can be released again and the shaft-bearing system can continue to operate supercritically. Short increases in vibration amplitude when passing through or resetting the clamping mechanism can be made uncritical by means of damping or design measures.
j) The fixing of the sliding bushing can be specifically controlled or regulated based on vibration amplitudes, vibration velocities, rotational speeds, thermal and/or mechanical conditions in the system.

Embodiment 1: Targeted, active clamping of sliding bushings with built-in roller bearing units, wherein the stiffness of shaft-bearing systems is changed depending on the application so that critical natural frequencies can be shifted and/or passed through at low or uncritical amplitude values, as shown in FIG. 1.

Embodiment 2: Targeted fixing of bearing units in sliding bushings according to or for embodiment 1, wherein one or more rolling bearings are installed in a sliding bushing which is fixed by means of mechanical (e.g. hydraulic, pneumatic, etc.) or electrical clamping mechanisms, as shown in FIG. 2.

Embodiment 3: Mechanical or electrical clamping mechanisms according to or for embodiment 2, wherein these establish a force-fit connection between the sliding bushing and the bearing shield, thereby increasing the axial and radial stiffness of the bearing system.

Embodiment 4: Mechanical or electrical clamping mechanisms according to embodiment 2, wherein these are installed or attached in the sliding bushing or in the bearing shield.

Embodiment 5: Mechanical or electrical clamping mechanisms according to embodiment 2, wherein these can be specifically activated and deactivated or regulated depending on one or more system-relevant input variables.

Embodiment 6: Targeted activation of the clamping mechanism according to embodiment 4, wherein the sliding bushing is clamped, thereby increasing the radial and axial stiffness of the shaft-bearing system, reducing the vibration amplitudes and allowing the radial eigenfrequency, as it would be without clamping, to be passed through. After passing through, the clamping can be released or maintained again, depending on the physical necessity and as specified by higher-level control or regulation mechanisms.

List of reference signs

| | |
|---|---|
| 1 | shaft |
| 2 | bearing |
| 3 | rolling element |
| 4 | bearing inner ring |
| 5 | bearing outer ring |
| 6 | clamping element |
| 7 | cavity |
| 8 | receiving element (bearing shield) |
| 9 | rotational speed sensor |
| 10 | temperature sensor |
| 11 | vibration sensor |
| 12 | bearing |
| 13 | rolling element |
| 14 | bearing inner ring |
| 15 | bearing outer ring |
| 17 | hydraulic line |
| 22 | mounting block |
| 23 | Sensor signal lines |
| 24 | controlling unit |
| 25 | hydraulic unit |
| 26 | control line |
| A | axis of rotation |
| v, v1, v2, vmax | vibration velocity |
| n, n₀, n₁, n₂ | rotational speed |
| n₃, n₄ | rotational speed |
| n_{A}, n_{B} | critical rotational speed |
| Δn | intermediate rotational speed interval |
| t | time |
| BZ1 | first operating state |
| BZ2 | second operating state |
| M_{A} | resonance maximum on curve (1) |
| M_{B} | resonance maximum on curve (2) |
| P1 | point on curve (1) at n₁ and v2 |
| P2 | point on curve (1) at n₂ and v2 |
| P3 | point on curve (2) at n₁ |
| P4 | point on curve (2) at n₃ and v2 |
| P5 | point on curve (2) at n₄ and v2 |
| P6 | point on curve (1) at n₃ |
| S, S₁, S₂ | stiffness |
| U1, U2 | switchover point |

1. Bearing shaft assembly comprising:
a) at least one shaft (1) which is rotatable or rotating about an axis of rotation (A) and which is mounted in at least one bearing (2, 12) arranged coaxially with the axis of rotation (A),
b) at least one clamping element (6) for exerting a clamping effect or clamping force between the at least one bearing (2) and at least one receiving element (8), in particular a bearing shield, wherein the at least one bearing (2, 12) is arranged between the at least one receiving element (8) and the shaft (1) or for exerting a clamping effect or clamping force between the bearing (2) and the shaft (1),
c) wherein the at least one clamping element (6) is controllable or controlled or activatable or activated, by means of a controlling unit (24), in such a way that, by increasing the clamping effect or clamping force, the stiffness of the bearing shaft assembly can be increased or is increased and/or a resonance range and/or an eigenfrequency of the bearing shaft assembly can be shifted or is shifted
d) wherein, in a first operating state (BZ1), the clamping element (6) has radial clearance with respect to the bearings (2 and 12) or the at least one receiving element (8) and does not exert any clamping force, in particular corresponding to a floating bearing, so that a first stiffness (S1) and/or a lower first eigenfrequency or a first resonance maximum (MA) results at a first critical rotational speed (nA), and
e) wherein, in at least one second operating state (BZ2), the clamping element (6) exerts a higher clamping force than in the first operating state, in particular in the manner of a fixed bearing, so that a second stiffness (S2) results which is higher than the first stiffness (S1), and/or a second eigenfrequency which is higher than the first eigenfrequency, or a second resonance maximum (MB) results at a second critical rotational speed (nB) which is higher than the first critical rotational speed (nA),
f) wherein, in the second operating state, the clamping element (6), after an initial expansion movement in the radial direction for overcoming the radial clearance, bears against the bearing (2, 12) or against the at least one receiving element (8) and is pressed against the bearing (2, 12) and/or against the at least one receiving element (8) to exert a clamping pressure or a clamping force,
g) wherein the controlling unit (24) switches or can switch between the operating states (BZ1 and BZ2) by controlling the clamping element (6) and adjusting its clamping force, thereby shifting or being able to shift the resonance range and/or the eigenfrequency of the bearing shaft assembly.

2. Bearing shaft assembly according to claim 1, in which the bearing (2, 12) comprises a sliding bushing in the manner of a floating bearing and the or the at least one clamping element (6) is integrated in the sliding bushing or is configured with the sliding bushing.

3. Bearing shaft assembly according to claim 1, wherein at least one clamping element is a hydraulically or pneumatically actuated or activatable clamping element and/or wherein at least one clamping element is an electrically or electromechanically actuated or activatable clamping element, in particular a wedge clamping element or a clamping sleeve.

4. Bearing shaft assembly according to claim 1, wherein the at least one or each bearing (2, 12) comprises rolling elements, in particular balls (3, 13), which are held between a bearing inner ring (4, 14) and a bearing outer ring (5, 15),
and/or
in which at least two bearings (2 and 12) are mounted one behind the other axially with respect to the axis of rotation (A).

5. Bearing shaft assembly according to claim 1, wherein at least one clamping element, in particular in a sleeve- or ring-shaped section, has at least one cavity (or: hollow space) (7) which, in particular by means of a hydraulic unit (25) connected to the controlling unit (24) via a control line (26) and connected to the at least one cavity (7) via at least one hydraulic line (17), can be filled or is filled with a hydraulic medium and can be subjected to a hydraulic pressure in the hydraulic medium,
wherein, preferably by means of the hydraulic pressure in the cavity (7), a region of the clamping element (6) positioned be-tween the cavity (7) and the bearing (2 or 12), in particular a membrane-like region, can be pressed or is pressed, in particular in the radial direction, against the bearing (2, 12) and/or against the at least one receiving element (8), in particular after an initial expansion movement to overcome a radial clearance and subsequent contact with the bearing (2, 12), preferably its outer ring (5, 15), or the at least one receiving element (8) and, due to the hydraulic pressure, can exert or exerts a clamping pressure or a clamping force, in particular a radial clamping force, of the clamping element (6) on the bearings (2, 12) and thus on the shaft (1).

6. (canceled)

7. Bearing shaft assembly according to claim 1,
a) in which the clamping element or the clamping force is or can be controlled or adjusted as a function of at least one or more operating quantities or operating parameters,
wherein the operating quantity or the operating parameter prefer-ably comprises at least one or more of the following:
(i) a vibration, preferably a vibration amplitude or a vibration velocity, in the bearing shaft assembly or a coupled component,
(ii) an operating temperature of the shaft and/or of the at least one bearing
(iii) the rotational speed of the shaft
(iv) a mechanical stress,
and/or
b) wherein at least one sensor (9, 10, 11) or a combination of sensors (9, 10, 11) is provided for detecting one or more of these operating quantities or operating parameters, the sensor(s) being preferably arranged in or on the bearing shaft assembly,
in particular
(i) at least one vibration sensor (11),
(ii) alternatively or additionally, at least one temperature sensor (10),
(iii) alternatively or additionally, at least one rotational speed sensor (9),
(iv) alternatively or additionally, at least one mechanical stress sensor.

8. Bearing shaft assembly according to claim 6, in which the controlling unit switches between the operating states depending on one or more of the operating quantities or operating parameters or on one or more of the sensor signals from one or more of the sensors, in particular when a critical threshold is reached.

9. Bearing shaft assembly, in particular according to claim 1, wherein a targeted, active clamping of sliding bushings with built-in roller bearing units, wherein the stiff-ness of the bearing shaft assembly is changed or can be changed depending on the application such that critical eigenfrequencies can be shifted and/or passed through at low or uncritical amplitude values, in particular by targeted fixing of the bearing units in the sliding bushings, wherein preferably one or more rolling bearings are installed in a sliding bushing, which are fixed by means of mechanical (e.g. hydraulic, pneumatic, etc.) or electrical clamping mechanisms, whereby the clamping mechanisms preferably establish a force-fit connection between the sliding bushing and the bearing shield, wherein the axial and radial stiffness of the bearing system is increased and/or wherein the clamping mechanisms are preferably installed or attached in the sliding bushing or in the bearing shield, wherein the clamping mechanisms can preferably be activated and deactivated or regulated in a targeted manner depending on one or more system-relevant input quantities.

10. Electric motor connected to a bearing shaft assembly according to one of the preceding claims.

11. Method for operating a bearing shaft assembly according to claim 1, comprising the following steps:
a) accelerating a rotatable shaft (1) of the bearing shaft assembly;
b) acquiring or monitoring a vibration parameter of an unwanted vibration of the bearing shaft assembly, such as a vibration amplitude or vibration velocity;
c) determining whether the vibration parameter reaches a critical threshold (v2);
d) when the critical threshold is reached, changing the stiffness of the bearing shaft assembly and/or shifting the resonance range and/or an eigenfrequency of the bearing shaft assembly by means of the at least one clamping element (6).

12. Method according to claim 11, wherein the acceleration of the shaft in a first operating state (BZ1) is carried out with a first stiffness (S1) and/or a lower first eigenfrequency or a first resonance maximum (MA) at a first critical rotational speed (nA) and, upon reaching the critical threshold and in at least one second operating state (BZ2), is switched over with a second stiffness (S2) which is higher than the first stiffness (S1), and/or a second eigenfrequency which is higher than the first eigenfrequency, or a second resonance maximum (MB) at a second critical rotational speed (nB) which is higher than the first critical rotational speed (nA),
wherein, preferably, upon further increasing the rotational speed of the shaft in the second operating state (BZ2), when the critical threshold is reached again, the system is switched back from the second operating state to the first operating state.

13. Method for operating a bearing shaft assembly according to claim 1, in which the bearing shaft assembly is operated in the second operating state (BZ2) and, by regular switching to the first operating state (BZ1), a relief of the clamping element (6) and/or the bearing shaft assembly is achieved.
